(19) United States
(12) Patent Application Publication
(10) Pub. No.: US 2008/0035675 A1
(43) Pub. Date: Feb. 14, 2008

(54) SYSTEMS, METHODS AND DEVICES FOR SUPPLYING COARSE GRANULAR MATERIALS TO A REMOTE LOCATION

(76) Inventor: Kris A. Norman, Edgerton, WI (US)

Correspondence Address: LATHROP & CLARK LLP, 740 REGENT STREET SUITE 400, P.O. BOX 1507, MADISON, WI, 537011507, US

(21) Appl. No.: 11/837,379

(22) Filed: Aug. 10, 2007

Related U.S. Application Data
(63) Continuation-in-part of application No. 11/464,430, filed on Aug. 14, 2006.

(51) Int. Cl. B67D 5/06

(52) U.S. Cl. 222/181.3

(57) ABSTRACT

A hopper, usable to supply material into an interior of a structure, includes walls that define a supply opening and a tapering supply space, a supply outlet and spout, a cover that extends over the supply opening, mounting structures that are attachable to the structure, and barrier structure(s) that extend across the supply opening. A guide surface inside the hopper guides the material to the supply outlet. The barrier structure(s) catch agglomerations of the material, and can be used to break up such agglomerations and/or to prevent large objects from the entering the supply space. The hopper is attached to wall(s) of the structure using the mounting structures. A supply pipe extends from the hopper through a floor/wall of the structure and terminates at an appliance to be supplied with the material using the hopper. The cover includes a gasket that seals the supply opening when the cover is closed.

### BACKGROUND OF THE INVENTION

1. Field of the Invention

This invention is directed to systems, methods and devices for supplying coarse granular material to a remote location, such as a location within a structure.

2. Related Art

Various appliances commonly used in residential or commercial structures include water softeners and furnaces. Once such conventional furnace is a pellet stove, which burns fuel pellets. Similarly, residential and commercial water softeners typically consume salt pellets. Consequently, it is necessary to regularly supply such appliances with the various coarse granular materials, such as fuel pellets or salt pellets, that these appliances consume. Typically, the appliance being supplied with the coarse granular material has a local storage structure or hopper that is used to store a supply of the coarse granular material as it is consumed by the appliance.

In many residential and commercial structures, these appliances are located in a basement or other below-grade room or areas of the structure. Such below-grade rooms in the structure are typically accessed using stairways, which are typically located in out-of-the-way areas of the structure. Accordingly, to re-supply such appliances with the necessary coarse granular materials, it is typically necessary to carry bags of the coarse granular material through the structure to the stairway, down the stairway, and then through one or more below-grade rooms or areas to reach the particular appliances being re-supplied with the coarse granular material. Typically, such bags of coarse granular material are heavy and unwieldy for the average person. For example, bags of salt pellets for water softeners typically weigh 40-80 pounds and are typically two to three feet long and approximately 18 inches wide.

For example, as shown in U.S. Pat. No. 6,561,387, a typical water softener includes a brine tank into which a supply of water softener pellets is provided. Similarly, as shown in U.S. Pat. 5,151,000, a pellet stove typically includes a hopper that stores a supply of the fuel pellets. Each of the '387 and '000 Patents are incorporated herein by reference in their entireties.

As shown in the incorporated '387 Patent and US Published Patent Application 2004/0188330, systems for supplying a below-grade-located water softener from a location above the below-grade water softener are known. As shown in the incorporated '387 Patent and '330 Published Patent Application, a typical system for supplying the brine tank of a water softener with water softener pellets includes locating a hopper at a point above the below-grade water softener and outside of the structure in which the below-grade water softener is located. A passageway is created in either the foundation or an exterior wall and a first supply tube or pipe is extended through the hole. Typically, the hole is angled downward toward the below-grade water softener. A second, downwardly-extending supply pipe is connected by an elbow to the end of the first pipe that is located within the below-grade space containing the water softener. The other end of the pipe extending through the exterior wall or foundation is provided with an upwardly-extending elbow. A generic, generally conical hopper is mounted to the upwardly-extending supply pipe.

### SUMMARY OF DISCLOSED EMBODIMENTS

As discussed in the incorporated '387 Patent and in the '330 Published Patent Application, the pipe leading to the below-grade water softener extends to a point that is located exterior to the structure containing the below-grade water softener. The generic hopper is detachably or demountably attached to the exterior wall of the structure and/or to the supply pipe. Accordingly, to use the various systems disclosed in these references, the user must locate the generic hopper and attach it to the supply pipe prior to being able to use the hopper/pipe system to supply the water softener with the water softener pellets. Subsequently, the user must detach the generic hopper, locate and re-attach a cap or other sealing structure to the exposed end of the supply pipe, and re-store the generic hopper in a location where the hopper is likely to be secure.

Unfortunately, it is not unlikely that the detached hopper could be misplaced, stolen, and/or inadvertently discarded, and/or its storage location forgotten. However, because only a generic hopper is disclosed, the hopper cannot remain attached to the supply pipe, lest rain, leaves or other debris, or the like fall into, or otherwise become located within, the hopper, such that such improper materials travel down the supply pipe and into the brine tank of the water softener. Furthermore, such a permanently-attached generic hopper would be a highly-attractive nuisance for vandals, children, whether acting maliciously or not, and the like, who would be tempted to introduce noxious or otherwise inappropriate materials into the hopper, and ultimately into the brine tank of the water softener. Additionally, because the generic hopper is not easily secured either to the supply pipe or to the structure, it can become damaged and/or inadvertently detached, and could make maintenance of the exterior of the structure and/or the surrounding landscaping difficult.

This invention provides a hopper usable to supply coarse granular materials to a device that consumes such coarse granular materials.

This invention separately provides a hopper usable to supply coarse granular materials to a below-grade location of a structure.

This invention separately provides a hopper that is easily attached to an interior or exterior wall of a structure.

This invention separately provides a hopper having a reduced profile in a direction perpendicular to a wall of a structure.

This invention separately provides a hopper having a lid or cover.

This invention separately provides a hopper having a hood-type lid or cover.

This invention separately provides a hopper having a securable lid or cover that can be secured in a closed position.

This invention separately provides a hopper having an interior guide surface usable to direct a coarse granular material out of a supply or discharge opening.

This invention separately provides a hopper having a structure usable to at least trap substantial agglomerations of the coarse granular material to be supplied through the hopper.

This invention separately provides a hopper having a structure usable to prevent objects over a desired size from entering the hopper.

This invention separately provides a hopper defining one or more areas into which an insulating material can be placed.

This invention separately provides a system for supplying a coarse granular material into a structure using an improved hopper.

This invention separately provides systems and methods for supplying a coarse granular material to the interior of a structure.

In various exemplary embodiments, a hopper usable to supply a coarse granular material into an interior of a structure according to this invention includes one or more of, or all of, a front assembly and a back assembly, the front and back assembly as defining a material supply space, a supply opening into which a coarse granular material can be supplied to the material supply space and a supply or discharge exit or outlet opening through which the coarse granular material can be supplied to the interior of the structure, a lid that at least extends over the supply inlet opening, mounting structures on at least one of the front and back assemblies that permit the hopper to be attached to the structure, and one or more bars, rods, other appropriate structure, or the like that extend across the supply opening.

In various other exemplary embodiments, a hopper usable to supply a coarse granular material into an interior of a structure according to this invention includes a front wall, a top wall, a back wall and a pair of side walls, the front, top back and side walls defining a material supply space, a supply opening into which a coarse granular material can be supplied to the material supply space and a supply or discharge exit or outlet opening through which the coarse granular material can be supplied to the interior of the structure, a lid that at least extends over the supply inlet opening, mounting structures on the side walls that permit the hopper to be attached to the structure, and one or more bars, rods, other appropriate structure, or the like that extend across the supply opening.

In various other exemplary embodiments, a hopper usable to supply a coarse granular material into an interior of a structure according to this invention includes an outer shell and an inner shell. The outer shell rests on a support surface and supports the inner shell at an appropriate height from the support surface. The inner shell includes a front wall, a top wall, a back wall and a pair of side walls, the front, back and side walls defining a material supply space, a supply opening into which a coarse granular material can be supplied to the material supply space and a supply or discharge exit or outlet opening through which the coarse granular material can be supplied to the interior of the structure, a lid that at least extends over the supply inlet opening, and one or more bars, rods, other appropriate structure, or the like that extend across the supply opening. The outer shell includes side walls having mounting structures that permit the outer shell to be secured to the structure, and a rear wall that includes an opening through which the supply or discharge exit or outlet opening extends.

In various exemplary embodiments, the lid or cover extends around at least one of the front and back assemblies over the supply opening. In various other exemplary embodiments, the lid engages the top wall of the inner shell or hopper over the supply opening. In various exemplary embodiments, the interior edges of the cover or lid include gasket material or the like that at least partially seals the supply opening when the lid or cover is in position. In various exemplary embodiments, a lock mechanism or the like is provided in the cover or lid, and a latch structure is provided, such that the lid or cover can be locked into a closed position.

In various exemplary embodiments, at least one of the front and back structures includes a material guide surface that guides the coarse granular material into the supply or discharge outlet or exit. In various other exemplary embodiments, one or more bottom walls or ledges define one or more material guide surfaces that guide the coarse granular material into the supply or discharge outlet or exit. In various exemplary embodiments, a plurality of bars, rods or the like are located in the supply space and extend across the supply opening. In various exemplary embodiments, a plurality of bars, rods or the like are formed as a unitary grate structure that is supported within the interior space of the hopper or inner shell. In various exemplary embodiments, the bars extend between the front and the back surfaces or walls. In various exemplary embodiments, the rods, bars or the like prevent agglomerations of the coarse granular material from continuing further into the supply space and exiting the hopper via the supply outlet opening. In various exemplary embodiments, the bars, rods or the like are usable to break up such agglomerations of the coarse granular material. In various exemplary embodiments, the rods, bars or the like are usable to prevent objects having dimensions greater than certain minimums from the entering the supply space and exiting the supply outlet opening.

In various exemplary embodiments, a system for supplying coarse granular material to an interior location in a structure comprises an improved coarse granular material supply hopper according to this invention that is attached to one or more interior or exterior surfaces or walls of the structure. A supply pipe extending through a wall and/or floor of the structure is attached to a back surface of the hopper adjacent to a supply outlet opening of the hopper. The supply tube extends into an interior space of the structure and terminates at an appliance to be supplied with the coarse granular material.

In various exemplary embodiments, a method according to this invention comprises unlocking a cover of a coarse granular material supply hopper, opening the cover, depositing a supply of the coarse granular material into the supply space of the hopper, passing the coarse granular material past a plurality of bars, rods or other structure(s) usable to break up agglomerations of coarse granular material, passing the coarse granular material from the plurality of bars, rods or other structure(s) to a supply outlet opening using a sloped and/or tapered surface, passing the coarse granular material through the supply outlet opening and into a supply pipe leading to an appliance to be supplied with the coarse granular material, returning the lid to the closed position, and relocking the lid.

These and other features and advantage of various exemplary embodiments of systems, methods and devices for supplying coarse granular materials to an interior location within a structure according to this invention are described in, or are apparent from, the following detailed description.

### BRIEF DESCRIPTION OF DRAWINGS

Various exemplary embodiments of coarse granular material hoppers and systems and methods for supply coarse granular materials according to this invention will be described in detail, with reference to the following figures, wherein:

FIG. 1 is a side/rear perspective view of a first exemplary embodiment of a coarse granular material hopper according to this invention;

FIG. 2 is a cut-away front/side perspective view of the coarse granular material hopper shown in FIG. 1;

FIG. 3 is a top view of the coarse granular material hopper shown in FIG. 1;

FIG. 4 is a rear plan view of one exemplary embodiment of a front

FIG. 5 is a front plan view of one exemplary embodiment of a back assembly of the coarse granular material hopper shown in FIG. 1;

FIG. 6 illustrates one exemplary embodiment of a system for supplying a coarse granular material into an interior location of a structure according to this invention;

FIG. 7 is a top view of a second exemplary embodiment of a coarse granular material hopper according to this invention;

FIG. 8 is a top view of a third exemplary embodiment of a coarse granular material hopper according to this invention;

FIG. 9 is a top view of a fourth exemplary embodiment of a coarse granular material hopper according to this invention;

FIG. 10 is a front/side perspective view of a fifth exemplary embodiment of a coarse granular material hopper according to this invention;

FIG. 11 is a rear/side perspective view of the inner shell of the coarse granular material hopper shown in FIG. 10;

FIG. 12 is a front plan view of the coarse granular material hopper shown in FIG. 10;

FIG. 13 is a rear plan view of the coarse granular material hopper shown in FIG. 10;

FIG. 14 is a side cross-sectional view of the coarse granular material hopper shown in FIG. 10;

FIG. 15 is a front cross-sectional view of the coarse granular material hopper shown in FIG. 10;

FIG. 16 is a front/side perspective view of a sixth exemplary embodiment of a coarse granular material hopper according to this invention;

FIG. 17 is a front plan view of the coarse granular material hopper shown in FIG. 16;

FIG. 18 is a rear plan view of the coarse granular material hopper shown in FIG. 16;

FIG. 19 is a side cross-sectional view of the coarse granular material

FIG. 20 is a front cross-sectional view of the coarse granular material hopper shown in FIG. 16.

### DETAILED DESCRIPTION OF EXEMPLARY EMBODIMENTS

The following is a detailed description of various exemplary embodiments of coarse granular material hoppers according to this invention and systems and methods for using such coarse granular material hoppers. As outlined above, conventional systems for supplying coarse granular materials to an interior location of a structure are problematic, in that such systems are typically designed to use a generic hopper and/or one that is designed to be detachable. The generic hopper is typically designed to be detachable, as generic, conical-shaped hoppers are neither easily attached to the structure or any other device, other than the supply pipe, that can provide any support or stability to the generic hopper. Furthermore, due to its size and shape, the generic, conical-shaped hopper extends a not-insignificant distance from the exterior wall of the structure. As a consequence, this generic hopper is also likely to be in the way, and thus a nuisance, when performing any landscape or maintenance activities near the generic hopper.

In various exemplary embodiments of coarse granular material hoppers according to this invention, a coarse granular material hopper is designed to fit flush against, or extend between the studs of, an interior or exterior wall of the structure. In various exemplary embodiments, whether the wall is an interior or exterior wall, and regardless of whether the wall is finished or not, coarse granular material hoppers according to this invention have a width sufficient to permit such coarse granular material hoppers to be readily attached or mounted between two studs of the wall of the structure. In various exemplary embodiments, this width is in part provided by mounting flanges or the like that extend laterally from the body of the coarse granular material hopper, and/or by mounting pockets or he like that extend laterally into the body of the coarse granular material hopper.

In various other exemplary embodiments, the body of the coarse granular material hopper according to this invention is sized such that it easily fits in a space provided between two adjacent studs. In such exemplary embodiments, the mounting flanges extend laterally from the body of the coarse granular material hopper such that when the flanges are mounted to the wall studs the body of the coarse granular material hopper is positioned within the wall between the adjacent studs.

In various other exemplary embodiments, the mounting flanges of a coarse granular material hopper according to this invention extended from the body of the coarse granular material hopper at an angle, such that the coarse granular material hopper can be located in a corner of the structure, extending between two adjacent walls. In such exemplary embodiments, the coarse granular material hopper according to this invention does not rest flush to or extend into, a wall. However, in such exemplary embodiments, a space is provided behind the coarse granular material hopper according to this invention, such that a hole or passage can be provided through the floor of the structure for the supply pipe to be attached to the rear of the coarse granular material hopper. Such exemplary embodiments are particularly useful when the appliance to be supplied with the coarse granular material is not located adjacent to or relatively near an appropriate outside wall and/or a portion of the structure having a wall sufficiently thick to allow the supply pipe to pass through the floor of the structure while remaining within the interior of the wall.

In various other exemplary embodiments, the coarse granular material hopper sits on a support surface, such as a floor or the like. In such exemplary embodiments, the coarse granular material hopper is secured to a wall, to studs or the like to prevent the coarse granular material hopper from being inadvertently displaced, but not necessarily to support the weight of the coarse granular material hopper and its contents.

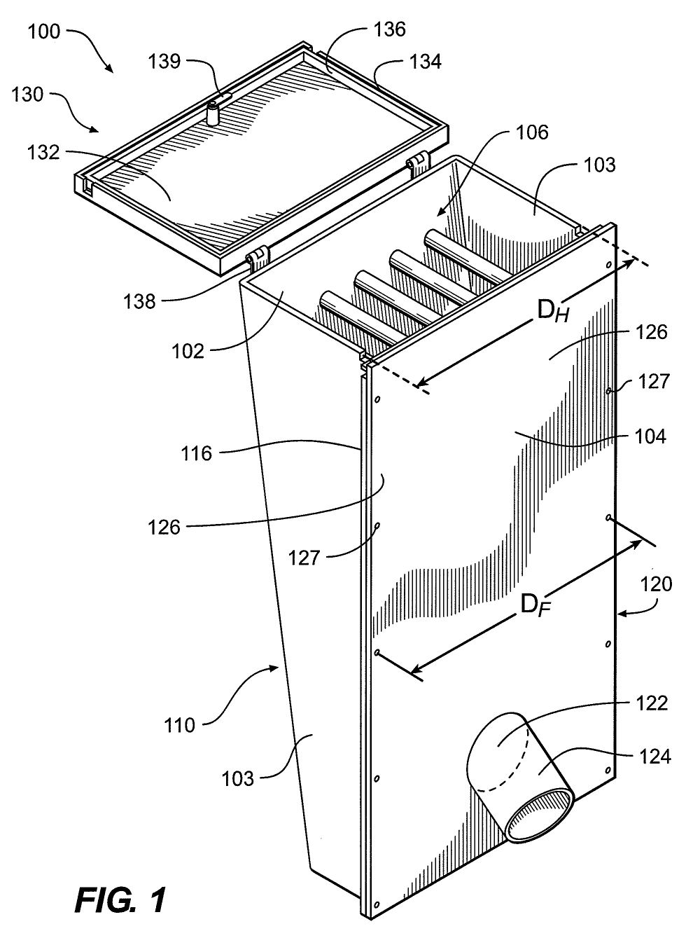

FIG. 1 is a rear/side perspective view of a coarse granular material hopper 100 according to this invention. As outlined above, the coarse granular material hopper 100 is usable to receive a supply of coarse granular material and to direct the coarse granular material through a pipe to a storage area for an appliance that consumes such coarse granular material. As shown in FIG. 1, the coarse granular material hopper 100 includes a front wall 102, a pair of side walls 103 and a rear wall 104 that, at least in part, define an interior space 106 that the coarse granular material is placed into. It should be appreciated that the coarse granular material hopper 100 can be molded or cast as a substantially integral structure or formed using sheet material. When formed using sheet material, in various exemplary embodiments, the front wall 102 and the side walls 103 are combined to form a front assembly 110, while the rear wall 104 forms the basis of a rear or back assembly 120. As shown in FIG. 1, in this exemplary embodiment, the front assembly 110 also includes mounting flanges 116 that extend laterally from the rear edges of the side walls 103.

As shown in FIG. 1, a plurality of rods, bars or one or more other barrier structures 114 extend across a top portion of the interior space 106 between the front and rear walls 102 and 104. Of course, the rods, bars or one or more other barrier structures 114 could just as easily extend between the side walls 103 or between all four walls 102-104.

As shown in FIG. 1, in various exemplary embodiments, the rear or back assembly 120 includes the rear wall 104, in which a supply outlet opening 122 has been formed. Typically, a supply spout 124 will be provided around the supply outlet opening 122. When provided, the supply spout 124 generally extends downwardly from the supply outlet opening 122 at an appropriate angle to allow a supply pipe (not shown) that leads to the appliance to be supplied with the coarse granular material to be attached to the supply spout 124 and thus the coarse granular material hopper 100.

As shown in FIG. 1, in various exemplary embodiments, the lateral edge regions of the rear assembly 120 surrounding the rear wall 104 of the coarse granular material hopper 100 form a pair of mounting flanges 126. Additionally, as shown in FIG. 1, each of the mounting flanges 126 includes a plurality of mounting holes 127. Typically, each of the mounting flanges 126 is provided with a plurality of the mounting holes 127. The mounting holes 127 allow the coarse granular material hopper 100 to be attached to the interior or exterior wall of a structure, for example. As shown in FIG. 1, in various exemplary embodiments, the center to center distance between the mounting holes 127 is a distance D_{F}. It should be appreciated that, in various exemplary embodiments, the distance D_{F} is approximately the standard center-center distance between two wall studs of a typical wall. In the United States, this standard center-center distance is typically 16 inches. In various exemplary embodiments, the mounting holes 127 are generally located near the center of the mounting flanges 126. In various exemplary embodiments, the mounting flanges 126 are each about 0.5 to about 1.5 inches wide. However, the mounting flanges 126 can be any desired width, so long as there is sufficient room to secure the flanges 126 to a wall or the like.

As shown in FIG. 1, in various exemplary embodiments, a distance D_{H} is the distance between the outer surfaces of the side walls 103, and thus is generally the width of the rear wall 104. The mounting flanges 126 are thus the portions of the back or rear assembly 120 outside of this distance D_{H} between the side walls 103. It should be appreciated that the supply outlet opening 122 can be provided at any location in the back or rear wall 104. However, it is typically most efficiently placed near a bottom of the coarse granular material hopper 100 and in a lateral central region of the rear wall 104. It should be appreciated that, while the supply outlet opening 122 is circular in FIG. 1, the supply outlet opening 122 can be any desired shape.

As shown in FIG. 1, a cover assembly 130 is connected to the front wall 102 of the coarse granular material hopper 100. In the exemplary embodiment shown in FIG. 1, the cover assembly 130 includes a lid 132 and a plurality of side walls 134 that extend away from the lid 132. In various exemplary embodiments, gasket material 136 is provided along the interior surfaces of the side walls 134. In various exemplary embodiments, the gasket material 136 is a rectangular annular gasket, such as an annular rubber seal. The cover assembly 130 is attached to the front wall 102 of the coarse granular material hopper 100 using a pair of hinges 138. The cover assembly 130 shown in FIG. 1 also includes a lock mechanism 139 that interacts with a latch structure (not shown) provided on or in the rear wall 104. Typically, the lock mechanism 139 extends through the lid 132 so that a key may be inserted into the locking mechanism when the cover assembly 130 is placed over the opening into the interior space 106 to allow access into the interior space 106.

As shown in FIG. 1, in various exemplary embodiments, an interior distance between the interior surfaces of the side walls 134 (if no gasket material 136 is provided, or between the interior surfaces of the gasket material 136 (when the gasket material 136 is provided) is at least about equal to the width of the hopper D_{H}. Additionally, the hinges 138 space the cover assembly 130 appropriately from the front wall 102 such that, when the cover assembly 130 is closed, the side wall 134 that is adjacent to the front wall 102 lies outside of, and extends downwardly over, the top edge of the front wall 102.

In various exemplary embodiments, the side wall 134 that is adjacent to the rear wall 104 when the cover assembly 130 is closed also extends over and downwardly from the top edge of the rear wall 104. In such exemplary embodiments, the tops of the mounting flanges 126 will be appropriately modified to allow the cover assembly 130 to close. In various other exemplary embodiments, the side wall 134 that is adjacent to the rear wall 104 when the cover assembly 130 is closed lies inside of the rear wall 104. In such exemplary embodiments, the side walls 103 and/or the left and right side walls 134 will be appropriate modified to allow the cover assembly 130 to close. Additionally, a channel or other structure can be provided on the top interior surface of the rear wall 104. This will be described in greater detail below.

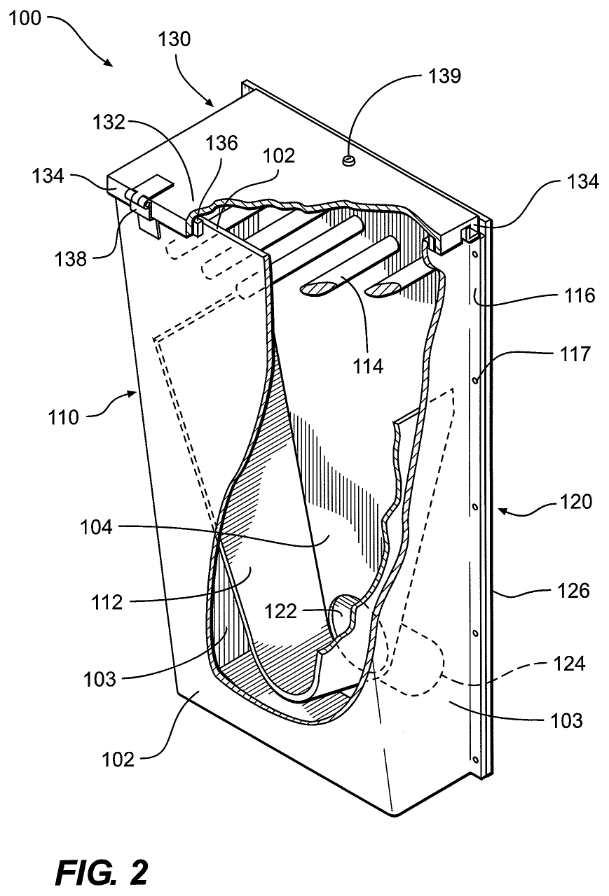

FIG. 2 is a cutaway front/top perspective view of one exemplary embodiment of the coarse granular material hopper 100 shown in FIG. 1. In particular, FIG. 2 shows the coarse granular material hopper 100 with the cover assembly 130 closed.

As shown in FIG. 2, when the cover assembly 130 is closed, the front and left and right side walls 134 extend over the top edges of the front wall 102 and the side walls 103 of the coarse granular material hopper 100. However, in the particular exemplary embodiment shown in FIG. 2, the rear side wall 134 is located in front of, rather than over the top edge of, the rear wall 104. In particular, in this exemplary embodiment, an L-shaped wall 123 extends inwardly from the rear wall 104 toward the front wall 102 and then extends upwardly, such that an upwardly-opening U-shaped channel is formed by the L-shaped wall 123 and the rear wall 104. In this exemplary embodiment, the rear side wall 134 of the cover assembly 130 extends into the U-shaped channel.

In various exemplary embodiments, the L-shaped wall 123 extends laterally outside of the side walls 103 and the left and right side walls 134 of the cover assembly 130. As a result, it is desirable to provide cuts in the top edges of the side walls 103 so that they fit around this L-shaped wall 123. Because the L-shaped wall also extends wider laterally than the left and right side walls 134 of the cover assembly 130, the left and right side walls 134 are also desirably provided with small cut-out areas to allow the side walls 134 to extend downwardly around the upwardly extending leg of the L-shaped wall 123 and the top edges of the front and side walls 102 and 103.

Thus, when the cover assembly 130 is closed, the rear side wall 134 of the cover assembly 130 is located inside the U-shaped channel, between the rear wall 104 and the upwardly extending leg of the L-shaped wall 123, while the left and right side walls 134 extend downwardly on either side of the upwardly extending leg of the L-shaped wall 123. With this structure, when the cover assembly 130 is closed, if any fluids are spilled on to the top of the cover assembly 130, should any of the spilled fluid run off of the top of the cover assembly 130 at the rear side wall 134, the fluid will run into the U-shaped channel formed by the rear wall 104 and the L-shaped wall 123. The fluid will then run laterally along that channel until the end of the L-shaped wall 123 is reached, which is laterally beyond the side walls 103 and the left and right side walls 134 of the cover assembly 130.

Similarly, if the fluid should run off of the lid 132 of the cover assembly 130 at the left or right side walls 134, because the left and right side walls 134 extend over the top edges of the side walls 103, any spilled fluid will stay on the outside surfaces of the side walls 103 and/or will run into the U-shaped channel. When the fluid runs out of the U-shaped channel, the fluid will again be located on the outside surface of the side walls 103. Similarly, should the spilled fluid run off of the lid 132 of the cover assembly 130 at the front wall 102, because the front side wall 134 of the cover assembly 130 extends over the stop edge of the front wall 102, the spilled fluid will flow on to the outer surface of the front wall 102.

Finally, if implemented, the gasket material 136 located around one or more of the inside surfaces of the side walls 134 will tend to prevent any such spilled fluid from moving upwardly along the top edges of the front or side walls 102 or 103 due to surface tension and/or capillary affects. As a result, the fluid is not able to flow into the interior space 106 of the coarse granular material hopper 100, and thus potentially contaminate any coarse granular material that may be loaded into the interior space 106 within the hopper or make its way into the appliance to be supplied using the coarse granular material hopper 100.

FIG. 2 also shows the mounting flanges 116 of the front assembly 110 in greater detail. As shown in FIG. 2, like the mounting flanges 126 of the sheet of material that forms the rear wall 104 of the rear assembly 120, the mounting flanges 116 include a plurality of mounting holes 117 and extend laterally away from the side walls 103 of the front assembly 110 about 0.5 inch to about 1.5 inches. However, like the mounting flanges 126, the mounting flanges 116 can be any desired size that allows the mounting flanges 116 to be attached to a wall. In particular, the mounting holes 117 are typically aligned with the mounting holes 127 formed in the mounting flanges 126.

As shown in FIG. 2, an angled guide wall 112 is positioned within the interior space 106 formed by the front, side and rear walls 102-104 of the coarse granular material hopper 100. The particular exemplary embodiment shown in FIG. 2, the angled guide wall 112 extends laterally from the side walls 103 from a point below the top edges of the side walls 103. In particular, in the specific exemplary embodiment shown in FIG. 2, the angled guide wall 112 begins about three or four inches below the top edge of the side walls 103. However, it should be appreciated that the top of the angled guide wall 112 can be located at any desired an appropriate position along the height of the side walls 103.

The angled guide wall 112 extends at an angle from the side walls 103 toward the supply outlet opening 122. In particular, the rear edge of the angled guide wall 112 closely approaches the supply outlet opening 122 and then follows the edge of the supply outlet opening 122 along at least a bottom most portion of the edge of the supply outlet opening 122. Accordingly, when the coarse granular material is loaded into the coarse granular material hopper 100, and falls downward from the top edges of the front, side and rear walls 102-104 toward the supply outlet opening 122, the angled guide wall 112 guides the coarse granular material into and through the supply outlet opening 122 and the supply spout 124. Thus, the angled guide wall 112 helps guide the coarse granular material out of the coarse granular material hopper 100 and through the supply outlet opening 122 into at least the supply spout 124.

In the exemplary embodiment shown in FIG. 2, the angled guide wall 112, in addition to being angled laterally from the side walls 103 toward the supply outlet opening 122, is also angled downwardly from the front wall 102 toward the rear wall 104 and the supply outlet opening 122. Like the lateral angle discussed above, this longitudinal angle helps the angled guide wall 112 guide the coarse granular material out of the interior space 106 of the coarse granular material hopper 100, through the supply outlet opening 122, and into at least the supply spout 124.

It should be appreciated that the angled guide wall 112 can extend from the side walls 103 toward the supply outlet opening 122 at a constant angle or at a varying angle, which can increase and/or decrease. Likewise, it should be appreciated that the angled guide wall 112 can extend from the front wall 102 toward the rear wall 104 and the supply outlet opening 122 at a constant angle or at a varying angle. As discussed above with respect to the lateral angle, this varying angle can increase and/or decrease. Finally, it should be appreciated that the angled guide wall 112 can have only a lateral angle and/or only a longitudinal angle. Likewise, it should be appreciated that while the angled guide wall 112 desirably approaches the edge of the supply outlet opening 122, the bottom portion of the upwardly-facing surface of the angled guide wall 112 does not need to be aligned with, or have any specific relationship to, the supply outlet opening 122 or the edge in the rear wall 104 that defines the supply outlet opening 122.

As shown in FIGS. 1 and 2, the supply outlet opening 122 will typically be circular. However, it should be appreciated that any desired and appropriate shape can be used for the supply outlet opening 122 and thus the supply spout 124 that extends at least partially around the supply outlet opening 122 and downwardly away from the rear wall 104. Typically, the supply spout 124 will be attached to a supply pipe or the like that has a circular cross section. Thus, a circular shape for the supply outlet opening 122 and the supply spout 124 may be particularly useful. However, it should be appreciated that the supply outlet opening 122 and/or the supply spout 124 can take any desired and appropriate shape.

As shown in FIG. 1, and as shown in greater detail in FIG. 2, a plurality of rods, bars or other barrier structures 114 extends between the interior surfaces of the front and rear walls 102 and 104 of the coarse granular material hopper 100. In the particular exemplary embodiment shown in FIGS. 1 and 2, the rods, bars or other barrier structures 114 are round bars or rods. The rods, bars or other barrier structures 114 can provide one or more of a number of disparate features. For example, if the rods, bars or other barrier structures 114 are spaced an appropriate distance apart based on the size and dimensions of the coarse granular material that the coarse granular material hopper 100 is used with, the rods, bars or other barrier structures 114 can be used to reduce the number of, and ideally eliminate, agglomerations of the coarse granular material that enter the interior space 106 below the rods, bars or other barrier structures 114 and thus exiting the coarse granular material hopper 100 through the supply outlet opening 122.

In such exemplary embodiments, agglomerations of two or more of the individual granules of the coarse granular material will be trapped above one or more of the rods, bars or other barrier structures 114. This gives the user the opportunity to break up such agglomerations before they enter the interior space 106 of the coarse granular material hopper 100. Otherwise, such agglomerations of the coarse granular material could be too large to fit through the supply outlet opening 122, and/or could be too large to readily travel down the supply spout 124 and through any pipes that the supplied coarse granular material must travel through until it reaches the location in the structure where it is to be stored pending further use.

In such cases, the user might have to dig through a large amount of the coarse granular material that is in the interior space 106 of the coarse granular material hopper 100 but which cannot get passed the agglomeration of the coarse granular material that is blocking the supply outlet opening 122. Should such an agglomeration be able to pass through the supply outlet opening 122 but become lodged within a supply pipe, the user would typically need to disassemble the supply pipe away from the coarse granular material hopper 100 while preventing the coarse granular material located within the coarse granular material hopper 100 from exiting the coarse granular material hopper 100. The user would then need to breakup or otherwise eliminate the agglomeration of the coarse granular material until it is able to readily travel down the pipe to the appliance to be supplied with the coarse granular material. The rods, bars or other barrier structures 114 allow this such agglomerations to be dealt with at a point where it is easier for the user to deal with such agglomerations.

Even if such agglomerations of the coarse granular material are not considered to be problematic, the rods, bars or other barrier structures 114 can be used to prevent objects from accidentally falling into or intentionally being placed into the interior space 106 of the coarse granular material hopper 100 and passing through the supply outlet opening 122 and into a pipe leading to the appliance to be supplied with the coarse granular material. Such objects could accidentally fall into the coarse granular material hopper 100 while the user is pouring the coarse granular material into the coarse granular material hopper 100.

In other circumstances, an inappropriate object could be placed into the coarse granular material hopper 100 intentionally by a child or other person who does not appreciate the consequences of doing so, or by a vandal or other person with malicious intent. To deal with such situations, the rods, bars or other barrier structures 114 can be provided such that the gaps between the rods, bars or other barrier structures 114 readily allow granules of the coarse granular material to pass between them and into the interior space 106 of the coarse granular material hopper 100, while preventing larger objects from easily passing by the rods, bars or other barrier structures 114 into the interior space 106. Another potential function for the rods, bars or other barrier structures 114 is to prevent a person, such as a small child, from falling into, or climbing into, the coarse granular material hopper 100, where the person could become struck and/or injured.

While FIGS. 1 and 2 show the rods, bars or other barrier structures 114 as being circular in shape, it should be appreciated that rods, bars or other barrier structures 114 of any desired shape can be used. It should also be appreciated that other shapes may have particular advantages, which increases the desirability of using such other shapes. For example, a rod, bar or other barrier structure 114 having a corner or edge along the top of the rod, bar or other barrier structure 114 may be useful in aiding the user to break up agglomerations of the coarse granular material. Similarly, rods, bars or other barrier structures 114 having triangular or rhombic cross sections may be useful to break up such agglomerations and/or to more effectively trap such agglomerations or inappropriate objects from entering the interior space 106 below the rods, bars or other barrier structures 114.

It should be appreciated that, in various exemplary embodiments, the rods, bars or other barrier structures 114 could be a grid or grate, formed of wire or plastic, for example, rather than the pipe-like rods or bars shown in FIGS. 1 and 2. In various exemplary embodiments, the rods, bars or other barrier structures 114 can be readily removable. This would be advantageous if the supply outlet opening 122, the supply spout 124 and/or a supply pipe became blocked, and/or if an inappropriate object or material was introduced into the interior space 106. In still other exemplary embodiments, one or a few bars or rods, along with a grate or grid that is attachable to one or more of the bars or rods can be used to implement the rods, bars or other barrier structures 114. In this case, the wire or plastic grid acts to trap large objects and agglomeration of coarse granular material. Then, should the user want or need to access the interior space 106, the user can remove the detachable grid or grate can be detached from the one or more few rods or bars.

As discussed above, in various exemplary embodiments, the mounting holes 127 have a center-to-center distance D_{F} that is equal to the typical center-to-center distance between two studs within a wall. In the United States and Canada, such center-center spacing for wall studs is typically 16 inches. By placing the center-to-center distance D_{F} generally equal to this center-center stud distance, the coarse granular material hopper 100 can be readily attached to a finished or unfinished interior or exterior wall of a structure. In various exemplary embodiments where the coarse granular material hopper 100 is designed to be attached between adjacent studs of a wall, the supply outlet opening 122 is typically located an appropriate distance away from the bottom edges of the front, side and rear walls 102-104. Along with the angle that the supply spout 124 extends downwardly from the supply outlet opening 122, this location for the supply outlet opening 122 is such that, when the coarse granular material hopper 100 is placed on a floor or other support surface and attached to the wall studs using the mounting holes 127, a hole can be provided in a floor and/or within the wall of the structure. This hole allows the supply spout 124 to be connected to a supply pipe or the like that will guide the coarse granular material from the coarse granular material hopper 100 to an appliance that consumes such coarse granular material.

It should be appreciated that, in various exemplary embodiments that use the L-shaped wall 123, the lock mechanism 139 can be located within the lid 132 of the cover assembly 130 such that the securing tab of the lock mechanism 139, when placed into a locked position, extends below the L-shaped wall 123. Thus, the cover assembly 130 can be locked into place, such that access to the interior space 106 of the hopper is generally prevented, without requiring any additional structures. In various other exemplary embodiments, where the L-shaped wall 123 is omitted, the lock mechanism 139 can be located in the lid of the cover assembly 130 such that the locking tab of the lock mechanism 139, when in the locked position, either extends under a ledge or shelf extending from the inwardly-facing surface of the rear wall 104, or extends into and possibly through a recess or slot formed in the rear wall 104.

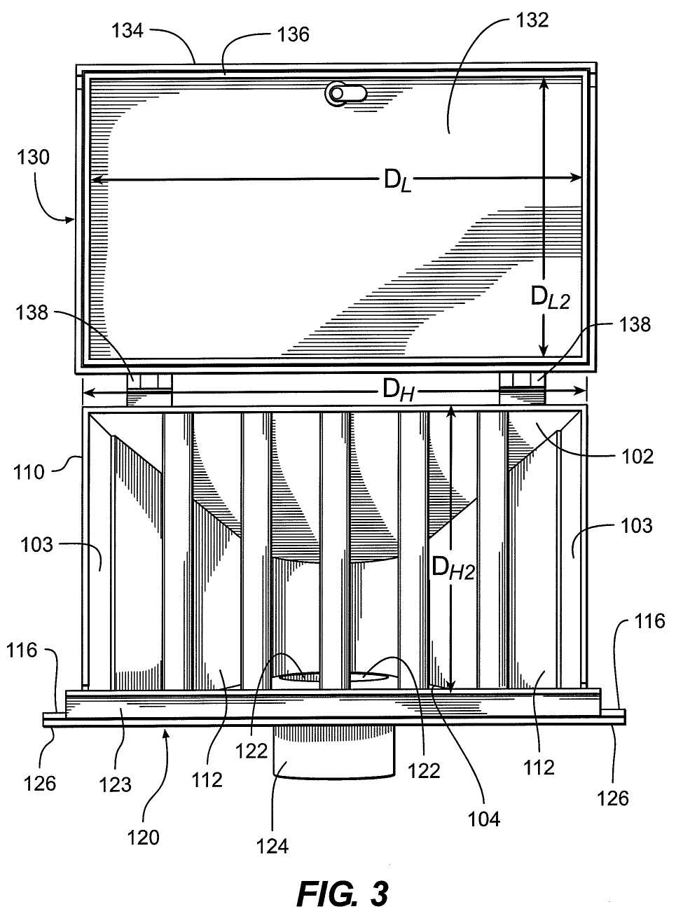

FIG. 3 is a top plan/perspective view of the exemplary embodiment of the coarse granular material hopper shown in FIGS. 1 and 2. In particular, FIG. 3 shows in greater detail the L-shaped wall 123 that extends from the inwardly-facing surface of the rear wall 104. FIG. 3 also shows in greater detail that the mounting flanges 116 are below the L-shaped wall 123, and the cuts in the left and right sidewalls of the cover assembly 130. FIG. 3 also shows that an interior distance D_{L} between the inner faces of the gasket material 136 provided on the left and right side walls 134 of the cover assembly 130 is at least equal to the distance D_{H} between the outer surfaces of the side walls 103 of the front assembly 110.

Likewise, FIG. 3 shows that the distance D_{H2} between the outer surface of the front wall 102 and the rear facing surface of the upwardly-extending leg of the L-shaped wall 123 is at least equal to the distance between the inner faces of the gasket material 136 placed on the front and rear side walls 134 of the cover assembly 130. Thus, when the cover assembly 130 is moved from the open position, shown in FIG. 3, to the closed position, the left and right side walls 134, including the gasket material 136, lie outside of and extend over the top edges of the side walls 103. Likewise, the front side wall 134 of the cover assembly 130 lies outside of the front wall 102, while the rear side wall 134 and associated gasket material 136 lies outside of the upwardly-extending leg of the L-shaped wall 123. As shown in FIG. 3, the cuts in the left and right side walls 134 of the cover assembly 130 generally correspond with the upwardly-extending leg of the L-shaped wall 123 such that when the cover assembly 130 is closed, the upwardly-extending legs of the L-shaped wall 123 extend in to these cuts.

It should be appreciated that, in various exemplary embodiments, the front, side and rear walls 102-104 can be shaped such that, when the cover assembly 130 is in the closed position, the lid 132 slopes downwardly toward the front wall 102. In such exemplary embodiments, any liquids on this sloped lid 132 tend to run off the front edge. Such liquids include contaminants such as a noxious chemicals, motor oil or the like, that could be spilled on the lid 132 when the coarse granular material hopper 100 is located in a garage, a utility room, a storage closet or the like. Such liquids can also include rain, snow and the like when the coarse granular material hopper 100 is located against an exterior wall of the structure.

A coarse granular material hopper 100 that is designed to be mounted outside of the structure can include any of a number of additional features. One such feature is insulation that reduces heat losses that could occur due to the heat flow path the coarse granular material hopper 100 and any supply pipe can provide. In various exemplary embodiments, the areas under the angled guide wall 112 and behind the rear wall 104 can easily be provided with insulation. In other exemplary embodiments, insulation can also be provided on the inside and/or outside surfaces of the lid 132, the front and side walls 102 and 103 or other appropriate surfaces. Another such feature is that the outer surfaces of the coarse granular material hopper 100 are weather-proof, and optionally paintable. In this case, the color of the coarse granular material hopper 100 can be matched to that of the structure. Another such feature is that the outer surfaces of the coarse granular material hopper 100 can be slotted or otherwise appropriately prepared or the like, so that siding and trim can be attached to at least one of the outer surfaces of the front and side walls 102 or 103 of the coarse granular material hopper 100. Again, this allows the appearance of the coarse granular material hopper 100 to be matched to the appearance of the structure to which it is attached.

It should be appreciated that the coarse granular material hopper 100 shown in FIGS. 1-3 can be manufactured in a variety of ways. For example, in various exemplary embodiments, the coarse granular material hopper 100 can be made out of a thermoformed or thermo-set material and formed using injection molding or the like. In such exemplary embodiments, the coarse granular material hopper 100 can be formed with the cover assembly 130 being formed as one part and the front and rear assemblies 110 and 120 formed as a single, integrated unit. In such cases, the mounting flanges 116 and 126 would be replaced with a single flange structure 116/126.

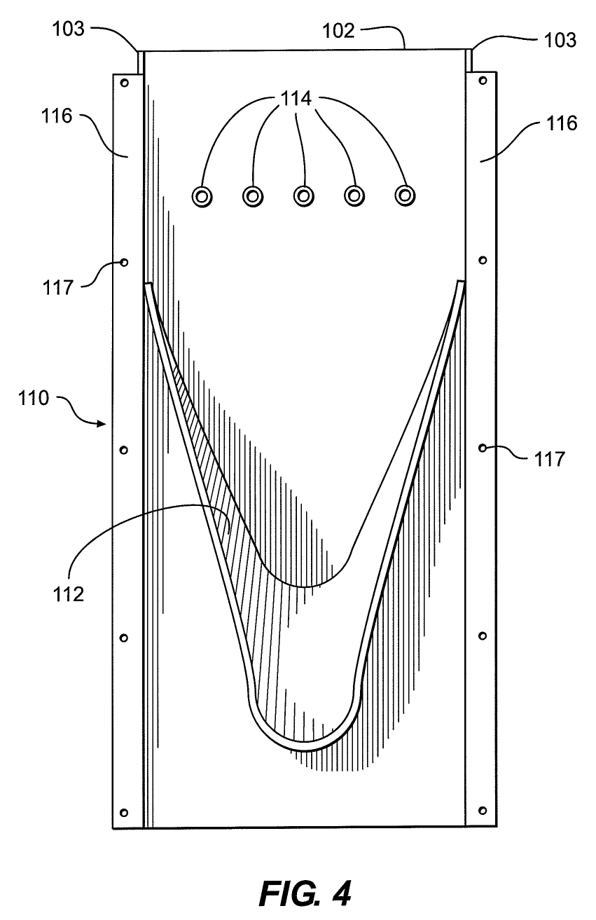

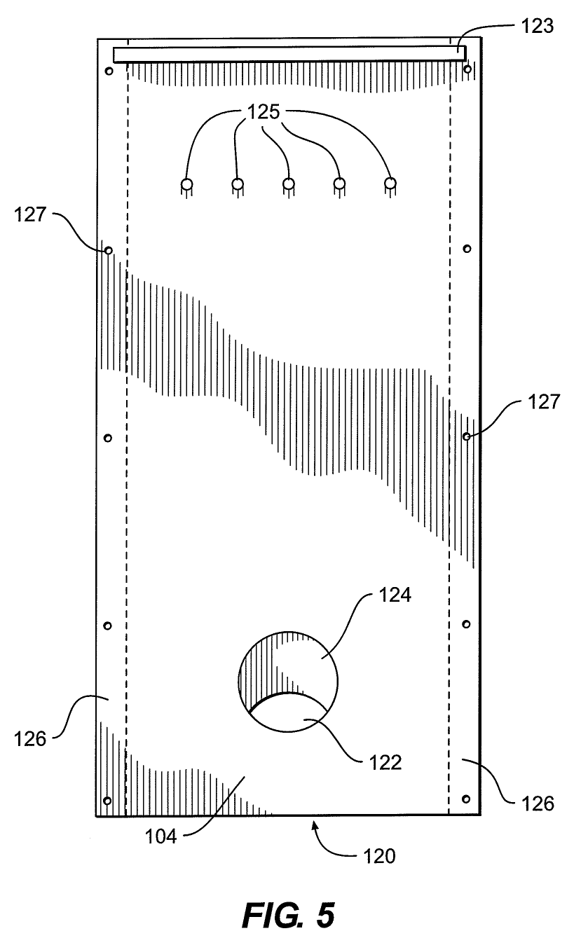

In various other exemplary embodiments, the front and rear assemblies 110 and 120 can be formed as separate assemblies, as shown in FIGS. 4 and 5. It should be appreciated that such separate assemblies can be formed out of various sheet materials, including metal sheets, plastic sheets and the like, or can be formed by injection molding, thermoforming, bending or the like. As indicated above, FIG. 4 is a rear plan view of the front assembly 110 of the exemplary embodiment shown in FIGS. 1-3. As shown in FIG. 4, the front assembly 110 includes the front wall 102 and the side walls 103, as well as the mounting flanges 116 that extend laterally from the rear edges of the side walls 103. A number of mounting holes 117 are formed in the mounting flanges 116. The angled guide wall 112 is positioned between the side walls 103 and against the front wall 102.

In various exemplary embodiments, the front and side walls 102 and 103 and the mounting flanges 116 are formed out of a single metal sheet that is bent appropriately. In such exemplary embodiments, the angled guide wall 112 is also made out of a sheet of the same or other appropriate metal. In various exemplary embodiments, the angled guide wall 112 is welded to the interior surfaces of the side walls 103 and/or the front wall 102. In various other exemplary embodiments, the angled guide wall 112 can be attached to the front and side walls 102 and 103 by brazing, using a plurality of fasteners, by using an adhesive, or by any other known or later-developed method that is appropriate for securing the angled guide wall 112 to the front and/or side walls 102 and/or 103. As shown in FIG. 4, in various exemplary embodiments, the angled guide wall 112 slopes both inwardly and downwardly at generally varying angles from both the top to bottom extents of the angled guide wall 112, as well as from the front to rear edges of the angled guide wall 112.

In the exemplary embodiment shown in FIG. 4, it should be appreciated that the rods, bars or other barrier structures 114 are shown as annular cylinders. In various exemplary embodiments, these annular cylinders can be attached to the front wall 102, such as by welding, brazing, gluing or the like, or can be loose members that can rotate and/or translate relative to the front wall 102. In such exemplary embodiments, a plurality of pegs or the like, such as the pegs 125 shown in FIG. 5, can be used to keep the annular cylinders used to implement the rods, bars or other barrier structures 114 at a desired location on the front wall 102.

FIG. 5 shows a front plan view of one exemplary embodiment of the rear assembly 120 according to this invention. As shown in FIG. 5, the rear assembly 120 includes the rear wall 104 at a central region of the rear assembly 120 and a pair of mounting flanges 126 that define the lateral edges of the rear assembly 120. As shown in FIG. 5, a plurality of mounting holes 127 are provided in the mounting flanges 126. Likewise, the supply outlet opening 122 is formed in the rear wall 104 of the rear assembly 120. A supply spout 124 is attached to the rear surface of the rear wall 104 of the rear assembly 120, such as by welding, brazing, gluing or the like. Similarly, a plurality of pegs or the like 125 are attached to the inwardly facing surface of the rear wall 104 of the rear assembly 120. When the front and rear assemblies 110 and 120 are assembled together, these pegs or the like 125 extend into the interior of the annular cylinders used to implement the rods, bars or other barrier structures 114. Thus, pegs or the like 125 act to hold the adjacent ends of the annular cylinders at a given location on the rear wall 104 of the rear assembly 120.

In various exemplary embodiments, as shown in FIGS. 1-5, the coarse granular material hopper 100 is generally wider front-to-rear at the top edges of the front, side and rear walls 102-104 than at the bottom edges of the front, side and rear walls 102-104. This narrowing taper from the top to the bottom of the coarse granular material hopper 100, toward the structure to which the coarse granular material hopper 100 is attached, tends to minimize the space used by the coarse granular material hopper 100.

In various exemplary embodiments, the supply opening defined by the top edges of the front, side and rear walls 102-104 is sufficiently large that it is relatively easy to pour the coarse granular material into the interior space 106 without spilling the coarse granular material when pouring the coarse granular material from its bag into the interior space 106. In various exemplary embodiments, the hinges 138 hold up the cover assembly 130 such that the cover assembly 130 acts as a shelf on which a bag of the coarse granular material can be placed and/or manipulated before pouring the coarse granular material into the interior space 106. For example, a bag of the coarse granular material can be placed on the opened cover assembly 130, with the bottom portion extending over the interior space 106. The bottom of the bag can then be cut or ripped open, such that, when the bag is lifted up and towards the structure, the coarse granular material pours out of the opening in the bag directly into the interior space 106.

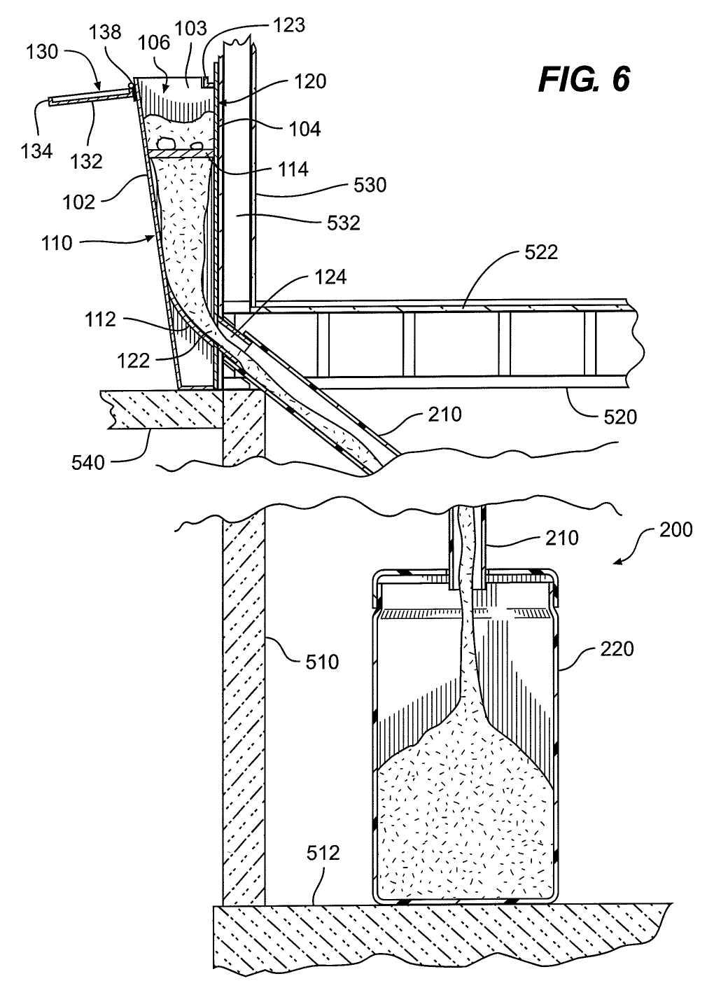

FIG. 6 is a cross-sectional view of one exemplary embodiment of a coarse granular material supply system 200 usable to supply one or more appliances 220, when the appliance 220 is located within a structure 500, with a coarse granular material using the coarse granular material hopper 100 according to this invention. As shown in FIG. 6, the structure includes a foundation 510, comprising a foundation floor 512 and a foundation wall 514. A joist structure 520 or the like is provided over the foundation 510 and sits on the weight-bearing foundation wall 514. The structure wall 530 sits on a top surface or floor 522 of the joist structure 520. A second foundation structure 540, such as the concrete floor of a garage, a carport, or a driveway, is located laterally adjacent to the foundation wall 514. The appliances 220 to be supplied with the coarse granular material are located within the structure below the joist structure 520, typically sitting on the foundation floor 512.

As shown in FIG. 6, in various exemplary embodiments, the coarse granular material hopper 100 is positioned such that it sits on the second foundation structure 540 adjacent to the joist structure 520 and the structure wall 530. In particular, the supply spout 124 of the coarse granular material hopper 100 extends through a hole cut in the joist structure 520 and is connected to a supply pipe 210 that extends between the supply spout 124 and the top of one such appliance 220. In particular, the supply pipe 210 extends either through an open space in the joist structure 520, or through a hole cut into a bottom surface of the joist structure 520. Although not clearly shown, the coarse granular material hopper 100 has been attached by its mounting flanges 116 and/or 126 to the structure wall 530 of the structure 500. In particular, in this exemplary embodiment, the coarse granular material hopper 100 has been attached to the outside surface of the structure wall 530.

As shown in FIG. 6, the cover assembly 130, which is hinged to the front wall 102, extends away from the structure wall 530 when the cover assembly 130 is opened. This allows the user to pour a supply of the coarse granular material into the coarse granular material hopper 100 such that the coarse granular material flows past the rods, bars or other barrier structure 114, out the supply outlet opening 122, through the supply spout 124 and the supply pipe 210, and into the storage portion of the appliance 220. As shown in FIG. 6, the rods, bars or other barrier structure 114 have prevented a pair of agglomerations of the coarse granular material from passing through them into the interior space 106 below the rods, bars or other barrier structure 114, where such agglomerations could become lodged in the supply outlet opening 122, the supply spout 124, and/or the supply pipe 210. Once the user has finished supplying the amount of the coarse granular material to the coarse granular material hopper 100, the user closes the cover assembly 130 and returns the lock mechanism to the locked position to prevent any inadvertent or malicious access to the interior space 106 of the coarse granular material hopper 100. As indicated above, this also prevents any materials from inadvertently falling into the interior space 106 of the coarse granular material hopper 100.

In various exemplary embodiments, two or more different coarse granular material-consuming appliances 220 could be located on the lower level of the structure 500. Moreover, the two or more different appliances 220 could consume two or more different types of coarse granular material. For example, one such appliance 220 could be a water softener, while another such appliance 220 could be a fuel pellet stove or furnace. In various exemplary embodiments, the same coarse granular material supply system 200 could be used to supply the appropriate coarse granular material to each such appliance 220.

In particular, in such exemplary embodiments, the supply pipe 210, or at least a portion of it, can be designed to swivel or move between the two appliances 220. It should be appreciated that the movable portion of the supply pipe 210 can be connected to a supply inlet of the appliance 220, positioned over a supply opening of the appliance 220 or the like, so that the coarse granular material can be supplied to that appliance 220. However, it should be appreciated that the same coarse granular material hopper 100 can be used to supply each such appliance 220.

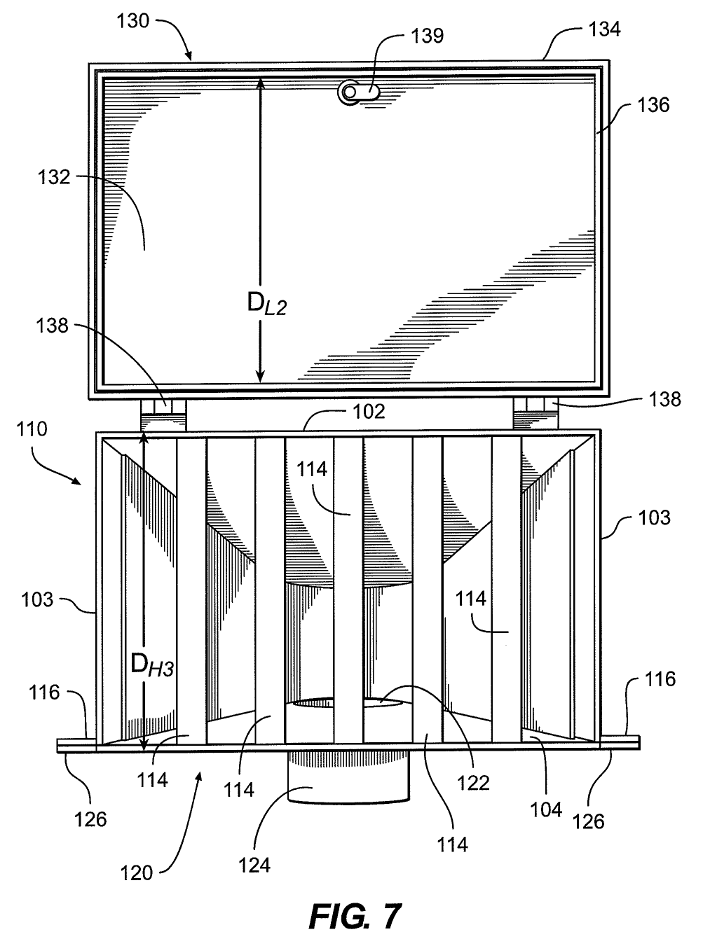

FIG. 7 shows a second exemplary embodiment of the coarse granular material hopper 100 according to this invention. In particular, in this exemplary embodiment, the cover assembly 130 extends over all four of the front and rear walls 102 and 104 and the two side walls 103. Accordingly, in such exemplary embodiments, the L-shaped wall 123 can be omitted. Additionally, both the mounting flanges 116 and the mounting flanges 126 will need to be shortened to allow the left and right side walls 134 of the cover assembly 130 to extend over top edges of the front, side and rear walls 102-104 of the coarse granular material hopper 100.

Thus, as shown in FIG. 7, the distance D_{L2} between the inner surfaces of the gasket material 136 placed on the front and rear side walls 134 of the cover assembly 130 is at least equal to or greater than the distance D_{H3} between the outer surfaces of the front and rear walls 102 and 104 of the coarse granular material hopper 100. In such exemplary embodiments, the securing tab of the lock mechanism 139 either extends under a ledge structure or the like (not shown) attached to the interior surface of the rear wall 104 or extends into and/or through a recess or slot formed in the rear wall 104.

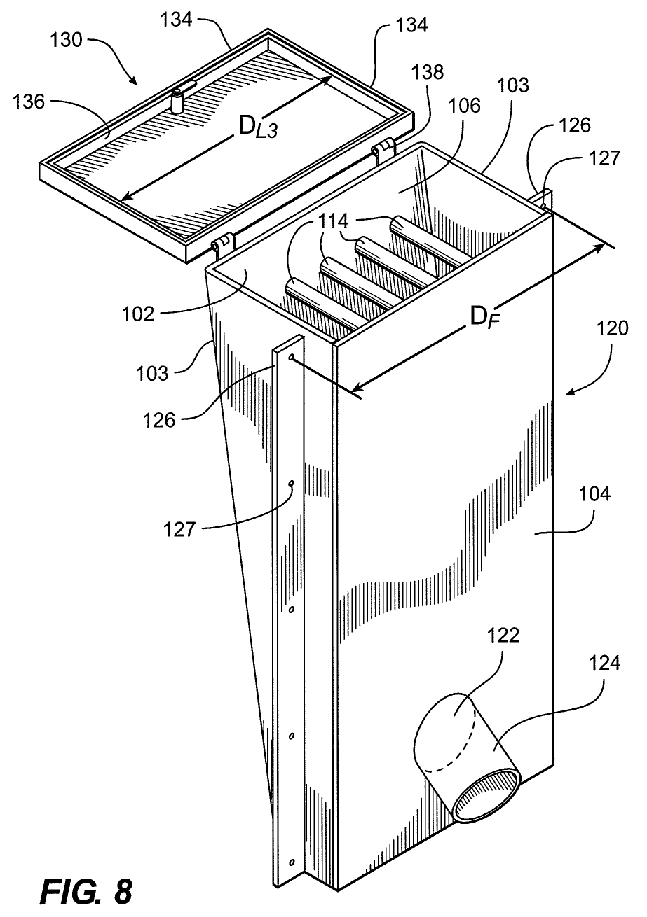

FIG. 8 shows a third exemplary embodiment of a coarse granular material hopper 100 according to this invention. As shown in FIG. 8, in this third exemplary embodiment, the flange or flanges 116/126, rather than being located at the rear wall 104 of the coarse granular material hopper 100, are instead located such that they extend laterally from the outer surfaces of the side walls 103. Like the first and second exemplary embodiments, in this third exemplary embodiment, the mounting holes 117/127 continue to have a standard center-to-center distance D_{F} that is roughly equal to the center-center distance between two studs of a wall.

However, by placing the flanges 116/126 within in the bounds of the side walls 103, the coarse granular material hopper 100 can be placed against a wall of a structure such that at least a portion of the coarse granular material hopper 100 extends into the wall between the adjacent wall studs. In such exemplary embodiments, a distance D_{L3} between the outer surfaces of the left and right side walls 134 of the cover assembly 130 at most just less than the distance between the facing surfaces of the two wall studs between which the coarse granular material hopper 100 is inserted. This allows the cover assembly 130 to be easily moved between the open and closed positions relative to the front, side and rear walls 102-104 of the coarse granular material hopper 100, without the wall studs inappropriately interfering with the movement of the cover assembly 130.

It should be appreciated that either of the structures for the cover assembly 130 and the corresponding portions of the rear wall 104 shown above in FIGS. 1 and 3 or FIG. 7 can be used with this third exemplary embodiment. It should further be appreciated that this third exemplary embodiment is particularly useful to reduce the distance that the coarse granular material hopper 100 extends away from the wall into which it is placed. For example, if space is at a premium, such that the first or second exemplary embodiments of the coarse granular material hopper 100 would extend too far way from the wall to which it is attached, this third exemplary embodiment can be used instead. Of course, it would be necessary for either the wall to be unfinished or for a portion of the dry wall, other wall covering or the like to be removed to allow this third exemplary embodiment of the coarse granular material hopper 100 to be inserted into the wall and to provide sufficient space to allow the cover assembly 130 to open and close.

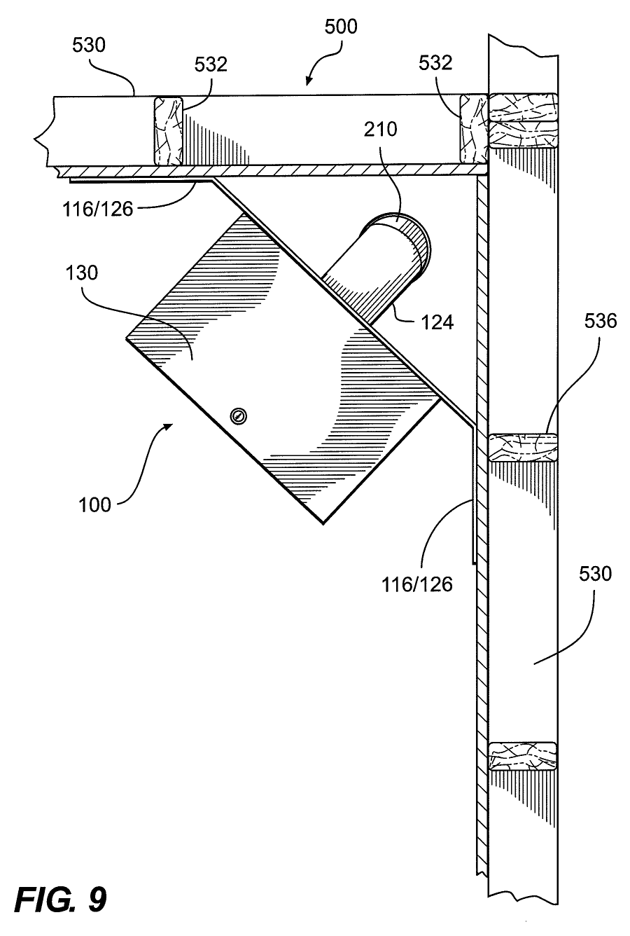

FIG. 9 is a top plan and cross-sectional view of a fourth exemplary embodiment of a coarse granular material hopper 100 according to this invention. In particular, in this fourth exemplary embodiment, the coarse granular material hopper 100 is modified to extend between, and to be attached to, a pair of intersecting structure walls 530 of the structure 500. As shown in FIG. 9, the flanges 116/126 extend from the side walls 103 of the coarse granular material hopper 100 at other than a 90° angle. In the exemplary embodiment shown in FIG. 9, the structure walls 530 are perpendicular to each other. The studs 532 to which the mounting flanges 116/126 are connected are roughly equally distant from the corner where the two structure walls 530 meet, although they do not need to be. In this exemplary embodiment, the mounting flanges 116/126 are generally at 45° angles to the side walls 103. Of course, any desired angles could be used depending on the locations of the studs 532 in the structure walls 530 and the angle at which the structure walls 530 meet. In various exemplary embodiments, the mounting flanges 116/126 adjustable relative to the coarse granular material hopper 100 with at least a small amount of effort, such that the angles that the mounting flanges 116/126 make with the side walls 103 can be adjusted so they are generally flush to the structure walls 530.

As shown in FIG. 9, by mounting this fourth exemplary embodiment of the coarse granular material hopper 100 in a corner of the two structure walls 530, a space behind the coarse granular material hopper 100 can be established where a hole can be cut into the floor 522 to allow the supply spout 124 and/or the supply pipe 210 to pass through the floor 522. This allow the coarse granular material supplied using the coarse granular material hopper 100 to be supplied to an appliance 220 located in a space below the floor 522.

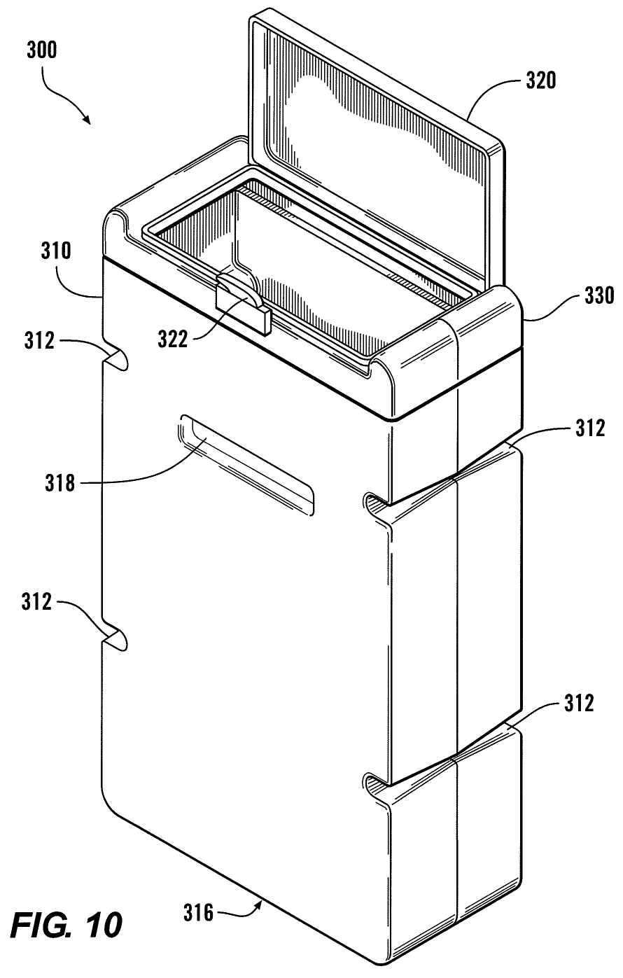

FIGS. 10-15 show various perspective, plan and sectional views of a fifth exemplary embodiment of a coarse granular material hopper 300 according to this invention. It should be appreciated that, in general, this fifth exemplary embodiment of a coarse granular material hopper 300 is formed using a high-impact plastic material and is shaped using injection molding, blow molding, or any other known or later-developed appropriate plastic molding technology.

As shown in FIG. 10, this fifth exemplary coarse granular material hopper 300 includes an outer shell 310, an inner shell 330 and a cover 320 mounted to the inner shell 330 that covers a top opening in the inner shell 330. As shown in FIG. 10, the outer shell 310 itself has a top opening into which the inner shell 330 is inserted. In this exemplary embodiment, the inner shell 330 extends out of the top opening in the outer shell 310. A locking mechanism 322 is located in the cover 320 and/or in the inner shell 330 to secure the cover 320 in a closed position, for all of the reasons outlined above with respect to the first-fourth embodiments shown in FIGS. 1-9.

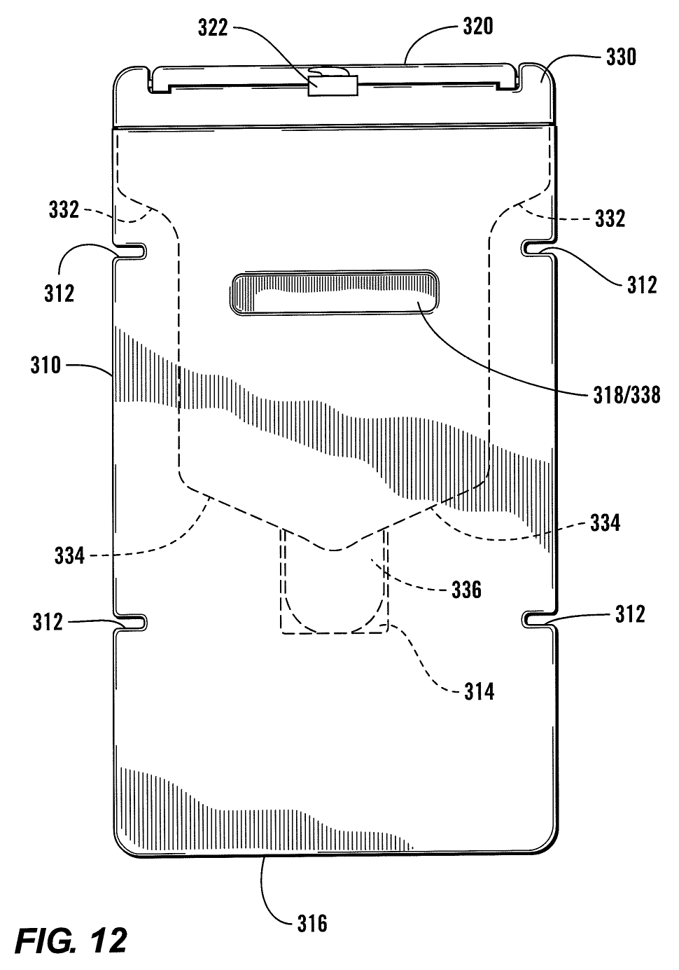

A number of mounting structures 312 are formed in the side walls of the outer shell 310. In this exemplary embodiment, the mounting structures 312 are indentations in the side walls, and in this exemplary embodiment have specially designed shapes, best seen in FIGS. 12-15 These mounting structures 312 allow bolts, screws, nails or any other appropriate known or later-developed fasteners to be inserted through the mounting structures 312 and into wallboard, one or more studs, masonry or the like that forms the wall that the coarse granular material hopper 300 is to be mounted to. The outer shell 310 also has recesses 318 that will be discussed in greater detail below.

In mounting the coarse granular material hopper 300 to the wall, the coarse granular material hopper 300 is placed with the bottom surface 316 of the outer shell 310 resting on a support surface, such as the bare ground, a floor, a concrete pad or the like that is adjacent to the wall. Thus, when the coarse granular material hopper 300 is mounted to the wall, the support surface, rather than the wall, bears the weight of the coarse granular material hopper 300 and any granular material present in the coarse granular material hopper 300. Accordingly, the fasteners extending through the mounting structures 312 need only secure the coarse granular material hopper 300 in place against any inadvertent movement of the coarse granular material hopper 300, rather than needing to support the weight of the coarse granular material hopper 300 and any granular material present in the coarse granular material hopper 300

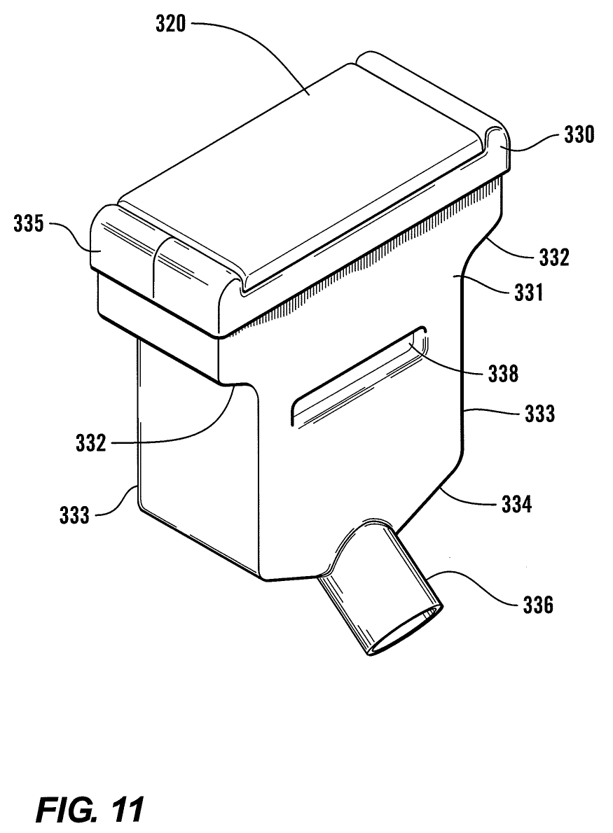

FIG. 11 is a rear/side perspective view of the inner shell 310 of the coarse granular material hopper 300 shown in FIG. 10. As shown in FIG. 11, the cover 320 is typically mounted to a top portion 335 of the inner shell 330, typically using plastic pins that are integrally molded into the cover 320. Alternatively, separate metal pins can be inserted into appropriately-shaped recesses formed in the cover 320 and the inner shell 330.

As shown in FIGS. 10 and 11, in various exemplary embodiments, the top portion 335 of the inner shell 330 engages the top edges of the front and side walls of the outer shell 310 when the inner shell 330 is inserted into the top opening formed in the outer shell 310. In this exemplary embodiment, the inner shell 310 also has generally flat front and rear walls 331 and specifically shaped side walls 333 that extend downwardly from the top portion 335. The side walls 333 extend down to bottom walls 334 that funnel down to a rear-facing outlet or spout 336 that extends from a bottom portion of the rear wall 331. The front and rear walls 331 also include recesses 338 that correspond to the recesses 318 formed in the front and rear walls of the outer shell 310.

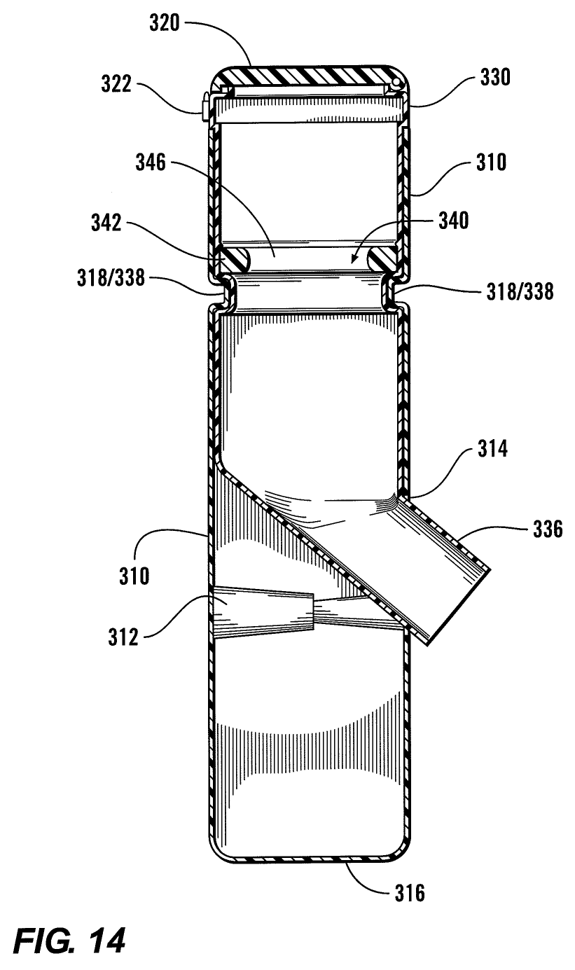

In the exemplary embodiment shown in FIG. 11, the side walls 333 include first ledges or ramps 332 that begins funneling the coarse granular material down towards the outlet or spout 336. These ledges or ramps 332 also reduce the lateral dimension of the side walls 333 so that there is sufficient room with in the outer shell 310 to form or provide the mounting structures 312. This can be better seen in FIG. 14. The bottom walls 334 extend at downwardly sloping angles from the side walls 333 to a generally bottom point or portion of the outlet or spout 336. This tends to efficiently guide the coarse granular material out of the interior of the inner shell 330 and into the outlet or spout 336. As outlined above, the outlet or spout is connectable, either directly or indirectly to the supply pipe 210.

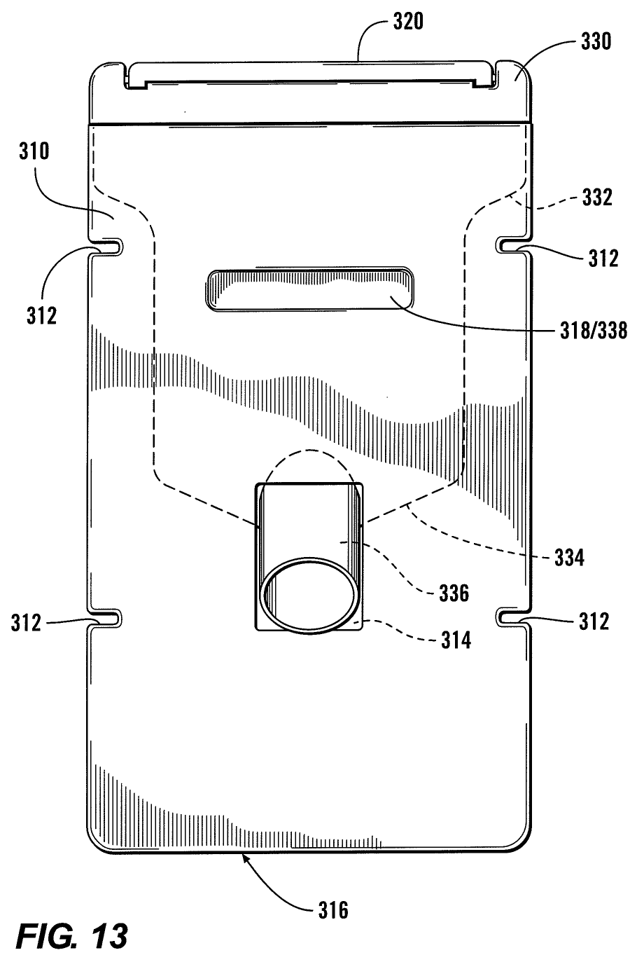

FIGS. 12 and 13 are front and rear plan views, respectively, of the coarse granular material hopper 300 shown in FIG. 10. In particular, FIGS. 12 and 13 show the portions of the inner shell 330 that lie within the outer shell 310 in shadow, illustrating how the inner and outer shells 330 and 310 interact. FIG. 13 also shows a rear opening 314 provided in the rear wall of the outer shell 310. As shown in FIG. 13, when the inner shell 330 is positioned in the outer shell 310, the outlet or spout 336 extends through the

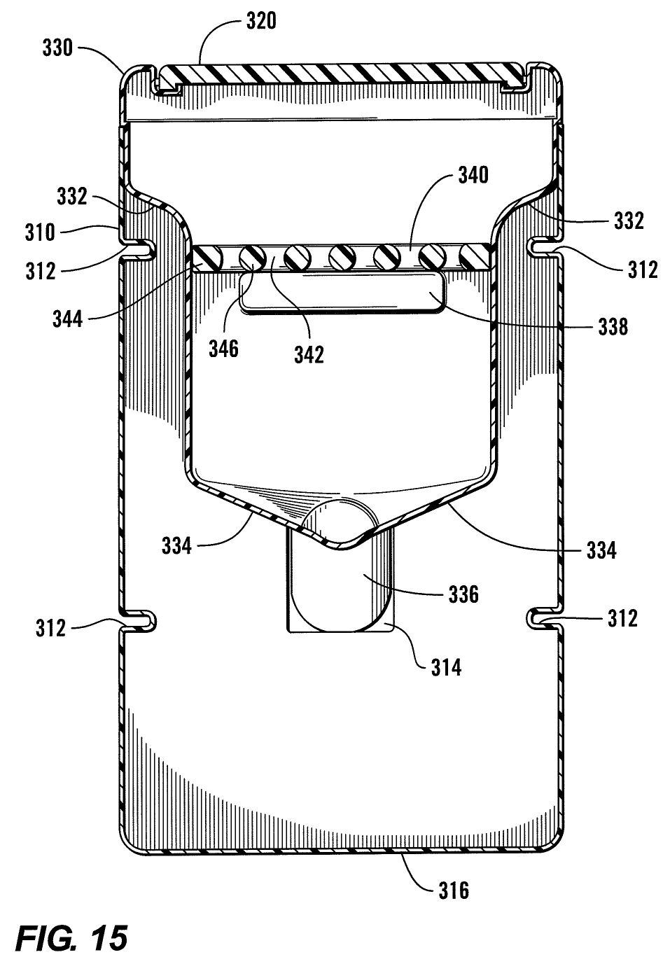

FIGS. 14 and 15 are side and front cross-sectional views of the coarse granular material hopper 300 shown in FIG. 10. As shown in FIG. 14, the recesses 318 in the outer shell fit into the recesses 338 in the inner shell. Furthermore, these recesses 318 and 338 provide a support surface in the interior of the inner shell 330 that supports a grid or barrier 340. In the exemplary embodiment shown in FIGS. 14 and 15, the grid or barrier 340 includes a pair of end portions 342 that rest on the support surfaces formed by the recesses 318 and 338. A plurality of end members 344 and rods 346 extend between the end portions 342. When the grid or barrier 340 is installed into the interior of the inner shell 330, the grid or barrier 340 provides the same functionality as the barrier structures 114 outlined above with respect to the first-fourth exemplary embodiments. FIG. 14 also shows in greater detail one exemplary embodiment of the mounting structures 312.

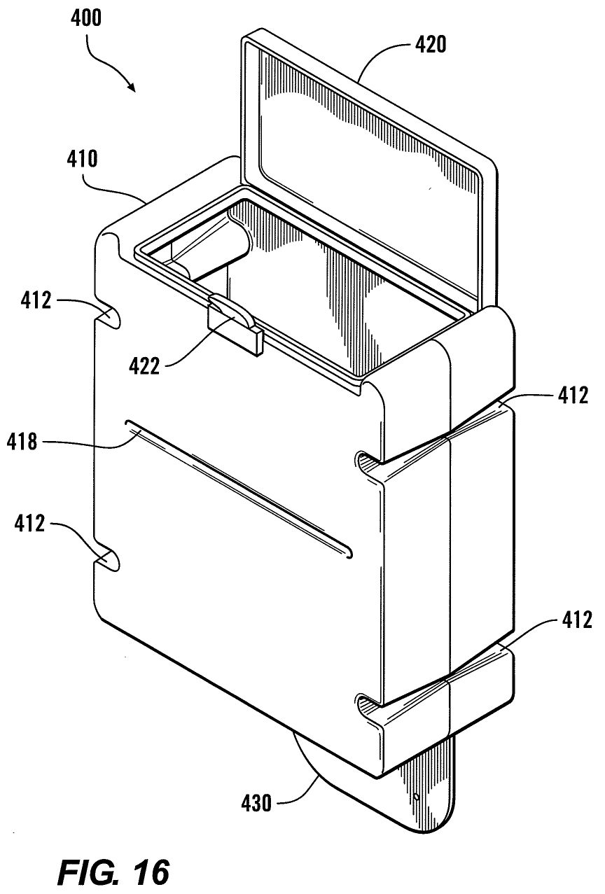

FIGS. 16-20 show various perspective, plan and sectional views of a sixth exemplary embodiment of a coarse granular material hopper 400 according to this invention. It should be appreciated that, in general, this sixth exemplary embodiment of a coarse granular material hopper 400 is formed using a high-impact plastic material and is shaped using injection molding, blow molding, or any other known or later-developed appropriate plastic molding technology.

As shown in FIG. 16, this sixth exemplary coarse granular material hopper 400 includes a housing 410 and a cover 420 mounted to the housing 410 that covers a top opening in the housing 410. A locking mechanism 422 is located in the cover 420 and/or in the housing 410 to secure the cover 420 in a closed position, for all of the reasons outlined above with respect to the first-fourth embodiments shown in FIGS. 1-9.

A number of mounting structures 412 are formed in the side walls of the housing 410. In this exemplary embodiment, the mounting structures 412 are indentations in the side walls, and in this exemplary embodiment have specially designed shapes, best seen in FIGS. 16-19 These mounting structures 312 allow bolts, screws, nails or any other appropriate known or later-developed fasteners to be inserted through the mounting structures 412 and into wallboard, one or more studs, masonry or the like that forms the wall that the coarse granular material hopper 400 is to be mounted to. The housing 410 also has recesses 418 that will be discussed in greater detail below.

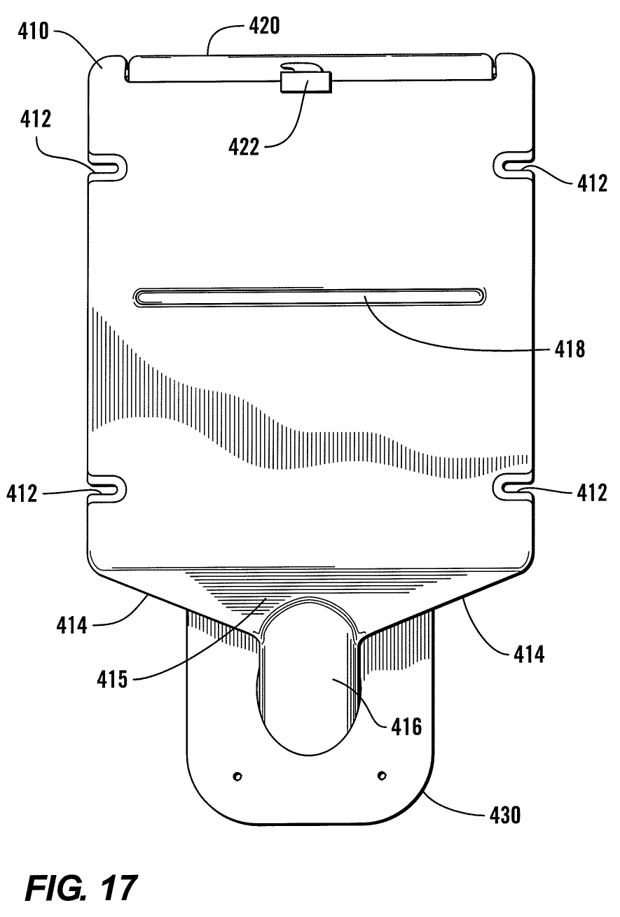

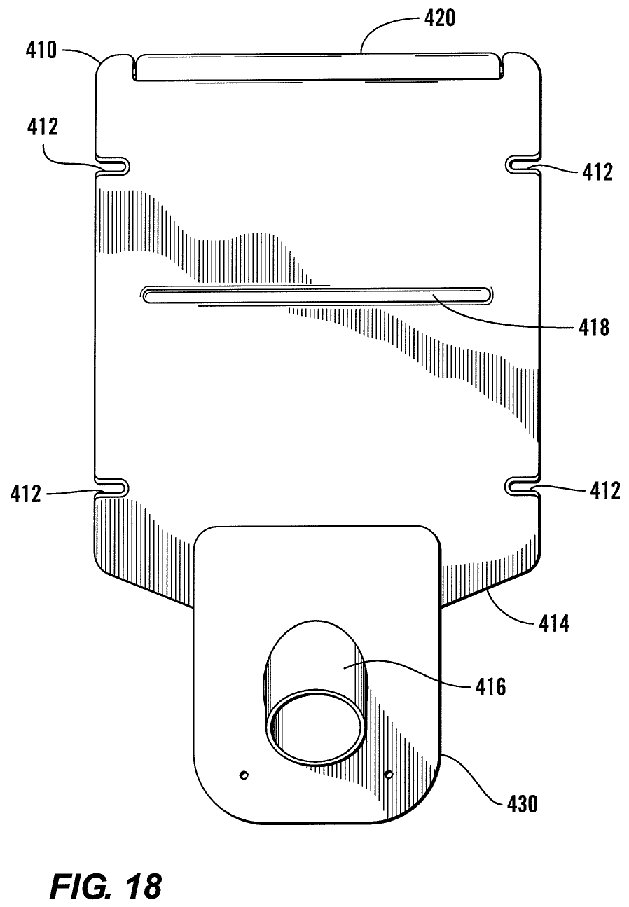

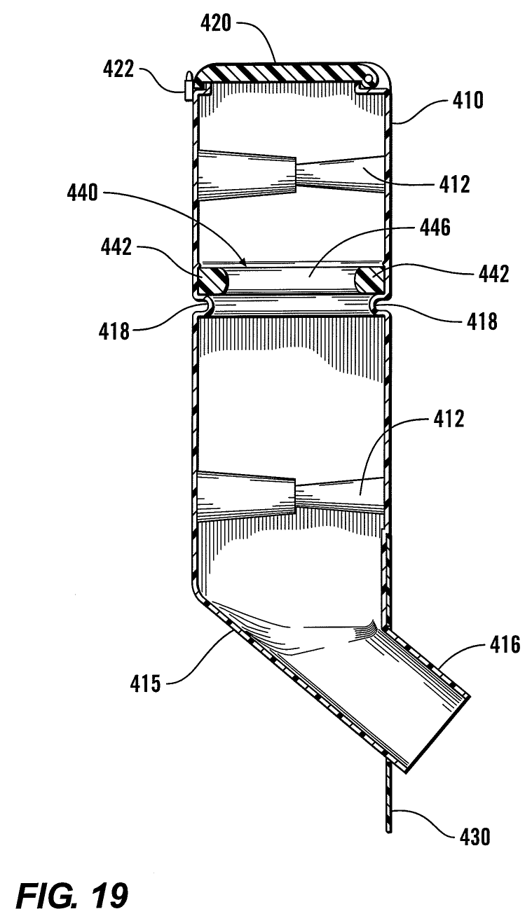

FIGS. 17 and 18 are front and rear plan views, respectively of the coarse granular material hopper 400 shown in FIG. 16. As shown in FIGS. 17 and 19, a bottom walls 414 of the housing 410 provide a sloped surface, while a shaped bottom wall 415 extends from the front wall of the housing 410 and morphs into a spout or outlet 416 that guides the coarse granular material out of the coarse granular material hopper 400. The bottom walls 414 and 415 funnel the coarse granular material into the outlet or spout 416. As shown in FIGS. 17 and 18, a mounting plate 430 is placed around the end of the spout 416. The mounting plate mounts to the wall the coarse granular material hopper 400 is mounted to and helps retain the outlet or spout in the desired position relative to the supply pipe 210 discussed above.

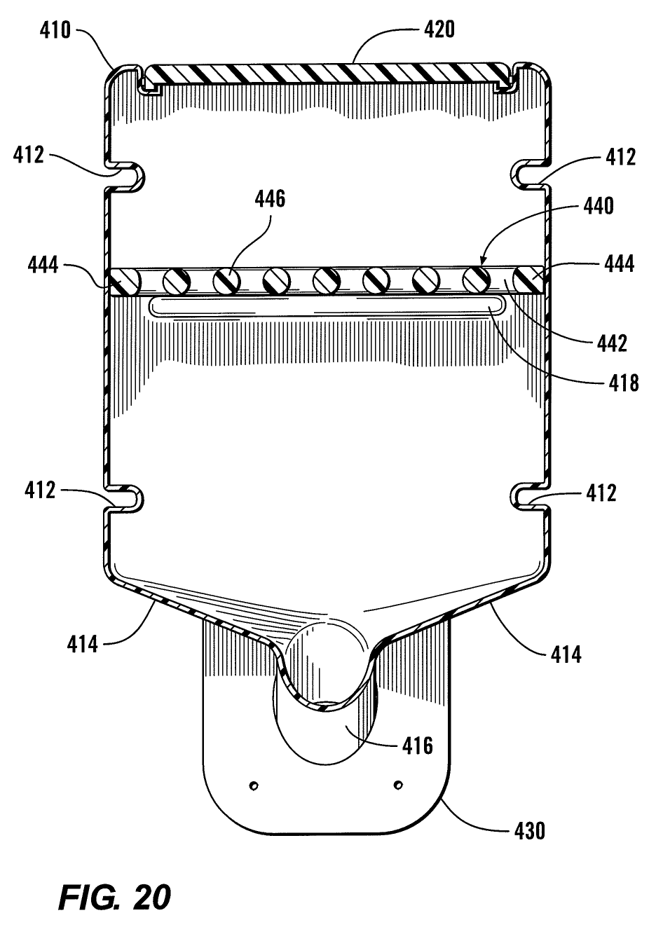

FIGS. 19 and 20 are side and front cross-sectional views of the coarse granular material hopper 400 shown in FIG. 16. As shown in FIG. 19, the recesses 418 provide a support surface in the interior of the housing 410 that supports a grid or barrier 440. In the exemplary embodiment shown in FIGS. 19 and 20, the grid or barrier 440 includes a pair of end portions 442 that rest on the support surfaces formed by the recesses 418. A plurality of end members 444 and rods 446 extend between the end portions 442. When the grid or barrier 440 is installed into the interior of the housing 410, the grid or barrier 440 provide the same functionality as the barrier structures 114 outlined above with respect to the first-fourth exemplary embodiments. FIG. 19 also shows in greater detail one exemplary embodiment of the mounting structures 312.

While the above-outlined exemplary embodiments have been described relative to supplying a coarse granular material using the coarse granular material hoppers 100, 300 and/or 400, it should be appreciated that any material, whether granular or not, or whether coarse or not, can be supplied using the coarse granular material hoppers 100, 300 and/or 400. Thus, the coarse granular material hoppers 100, 300 and/or 400 are not limited to supplying coarse or granular materials.

While this invention has been described in conjunction with the exemplary embodiments outlined above, various alternatives, modifications, variations, improvements and/or substantial equivalents, whether known or that are or may be presently foreseen, may become apparent to those having at least ordinary skill in the art. Accordingly, the exemplary embodiments of the invention, as set forth above, are intended to be illustrative, not limiting. Various changes may be made without departing from the spirit or scope of the invention. Therefore, the invention is intended to embrace all known or earlier developed alternatives, modifications, variations, improvements and/or substantial equivalents.

1. A hopper usable to supply a flowable material to a device that consumes such flowable material, the device located within a structure at a location within the structure that is separated from and below the hopper, comprising:
at least a front wall, a rear wall and a pair of side walls that define an interior space within the hopper;
a supply outlet opening formed in the rear wall;
an shaped guide surface extending between the front and rear surfaces and sloping downward from the front wall to the rear wall, the shaped guide surface further extending between the pair of side walls such that the shaped guide surface passes below at least a portion of the supply outlet opening, such that material supplied to the interior space is guided into the supply outlet opening;
mounting structures formed in or on the hopper such that the hopper is connectable to a wall of the structure;
wherein, when the flowable material is supplied into the interior space of the hopper, the flowable material is guided by the angled guide surface through the supply outlet opening.

2. The hopper of claim 1, wherein the front and rear walls oppose each other and the pair of side walls oppose each other.

3. The hopper of claim 1, further comprising a cover structure that extends over an opening to the interior space of the hopper defined by top edges of the front, rear and side walls of the hopper.

4. The hopper of claim 3, wherein the cover structure comprises:
a lid;
a plurality of side wall that extend from the lid; and
at least one connecting member that connects the cover structure to at least one of the front, rear or side walls of the hopper, the cover structure rotatably between a closed position where the lid extends over the opening and an open position where the lid is spaced away from the opening.
wherein at least three of the side walls of the cover structure extend outside of at least some of the front, rear and side walls of the hopper when the cover structure is in the closed position.

5. The hopper of claim 4, wherein the cover structure further comprises gasket material placed on inside surfaces of the plurality of side walls of the cover structure, such that a seal is established between the cover structure and at least some of the front, rear and side walls of the hopper when the cover structure is closed.

6. The hopper of claim 4, wherein:
the hopper further comprises a channel formed at least in part by the rear wall of the hopper, the channel opening upward, extending into the interior space, and extending laterally outside of the pair of side walls of the hopper; and
the cover structure is sized such that, when the cover structure is in the closed position, a rear one of the side walls extending from the lid that is adjacent to the rear wall is located in front of the rear wall and extends into the channel.

7. The hopper of claim 4, wherein:
wherein all of the side walls of the cover structure extend outside of all of the front, rear and side walls of the hopper when the cover structure is in the closed position.

8. The hopper of claim 1, wherein: 1
a front assembly comprises at least the front wall and the side walls of the hopper; and
a rear assembly comprises at least the rear wall of the hopper.

9. The hopper of claim 8, wherein the rear assembly further comprises a first set of flanges attached to the rear wall.

10. The hopper of claim 11, wherein the front assembly further comprises a second set of flanges, the second set of flanges extending from the side walls of the hopper such that the second set of flanges are adjacent to the first set of flanges of the rear assembly.

11. The hopper of claim 8, wherein the front assembly further comprises the angled guide surface.

12. The hopper of claim 11, wherein the angled guide surface is attached to at least one of the front wall and at least one of the side walls of the hopper.

13. The hopper of claim 8, wherein the front assembly further comprises a set of flanges, the set of flanges extending from the side walls of the hopper.

14. The hopper of claim 1, further comprising at least one barrier structure extending across the interior space, the at least one barrier structure usable to bar an object greater than a desired size from moving from above the at least one barrier structure to below the at least one barrier structure.

15. The hopper of claim 14, where in the at least one barrier structure extends at least one of between the front and rear walls and between the side walls.

16. The hopper of claim 14, where in the at least one barrier structure is one of at least a plurality of bars, a plurality of rods or a grid structure

17. The hopper of claim 1, wherein and a supply pipe extending from the appliance through a floor or the wall of the structure is connectable to the supply outlet opening, wherein, when the flowable material is supplied into the interior space of the hopper, the flowable material is guided by the angled guide surface through the supply outlet opening into the supply pipe.

18. The hopper of claim 1, further comprising a spout extending from an exterior surface of the rear wall and extending around the supply outlet opening formed in the rear wall.

19. The hopper of claim 1, wherein the mounting structure comprises a first set of flanges extending from the rear wall.

20. The hopper of claim 1, wherein the mounting structure comprises a first set of flanges attached to the side walls.

21. The hopper of claim 1, wherein the mounting structure comprises:
flanges extending from at least one of the rear wall and at least one of the pair of side walls; and
a plurality of mounting holes formed in the flanges, such that the hopper is connectable to a wall of the structure.

22. The hopper of claim 1, wherein the shaped guide surfaces is an angled guide surface located within the interior space, the angled guide surface extending between the front and rear surfaces and sloping downward from the front wall to the rear wall, the angled guide surface further extending between the pair of side walls such that the angled guide surface passes below at least a portion of the supply outlet opening, such that material supplied to the interior space is guided into the supply outlet opening.

23. The hopper of claim 1, wherein:
the front wall, rear wall and pair of side walls that define an interior space within the hopper form an inner shell, the hopper further comprising an outer shell that rests on a support surface and that extends around and supports the inner shell a distance above the support surface; and
the mounting structures formed in or on the hopper are formed in the outer shell.
